(19) United States
(12) Patent Application Publication
(10) Pub. No.: US 2004/0021362 A1
(43) Pub. Date: Feb. 5, 2004

(54) Barnes & barnes neck reliever

(76) Inventor: Ray A. Barnes, Bowdon, GA (US)

Correspondence Address: Ray A. Barnes, 3190 Victory Church Road, Bowdon, GA, 30108, US

(21) Appl. No.: 10/213,198

(22) Filed: Aug. 5, 2002

(51) Int. Cl. B60R 22/30

(52) U.S. Cl. 297/483

(57) ABSTRACT

A shoulder strap neck reliever for a seatbelt having two straps comprising a base with a front side and a back side, said base including an H-shaped slit having a left opening and a right opening, and a clip connected to said base defining a strap holding area therebetween, wherein the first strap is threaded into said left opening and along the back side of the base and threaded out through said right opening, and the second strap is clipped into said strap holding area.

The Barnes & Barnes seat belt shoulder strap Neck Reliever has been specifically designed for the sole purpose of providing the user with dramatically increased comfort. As a result the Neck Reliever encourages greater use of seat belt shoulder straps since one of the major reasons for their non-use is the discomfort afforded by standard seat belt shoulder strap arrangements.

The flexibility of the Neck Reliever results in a lack of hazardous edges or corners that could cause injury or penetrate the body in an accident. We have found that the use of the Neck Reliever prototype provides a decided advantage in safety in that it will, if adjusted according to the instructions, hold the shoulder strap flat, i.e. sideways, against the neck instead of the normal position. The normal position for the shoulder strap is lying flat on the shoulder thereby presenting a cutting edge similar to a sharp knife against the neck. The shoulder strap in its normal position under the pressure resulting from an automobile accident can, and has according to news reports, caused decapitation of users.

Although it would be difficult to adequately quantify the degree of comfort to one using the Neck Reliever, all users tested reported increased comfort compared to a standard seat belt shoulder strap arrangement.

The Barnes & Barnes seat belt shoulder strap Neck Reliever™ has been specifically designed for the sole purpose of providing the user with dramatically increased comfort. As a result the Neck Reliever encourages greater use of seat belt shoulder straps since one of the major reasons for their non-use is the discomfort afforded by standard seat belt shoulder strap arrangements.

The flexibility of the Neck Reliever results in a lack of hazardous edges or corners that could cause injury or penetrate the body in an accident. We have found that the use of the Neck Reliever prototype provides a decided advantage in safety in that it will, if adjusted according to the instructions, hold the shoulder strap flat, i.e. sideways, against the neck instead of the normal position. The normal position for the shoulder strap is lying flat on the shoulder thereby presenting a cutting edge similar to a sharp knife against the neck. The shoulder strap in its normal position under the pressure resulting from an automobile accident can, and has according to news reports, caused decapitation of users.

Although it would be difficult to adequately quantify the degree of comfort to one using the Neck Reliever, all users tested reported increased comfort compared to a standard seat belt shoulder strap arrangement.

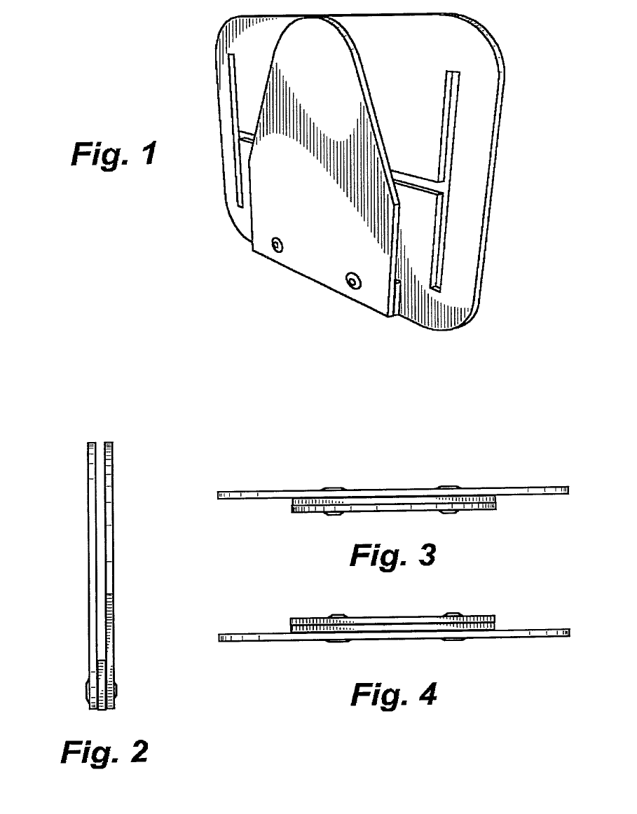

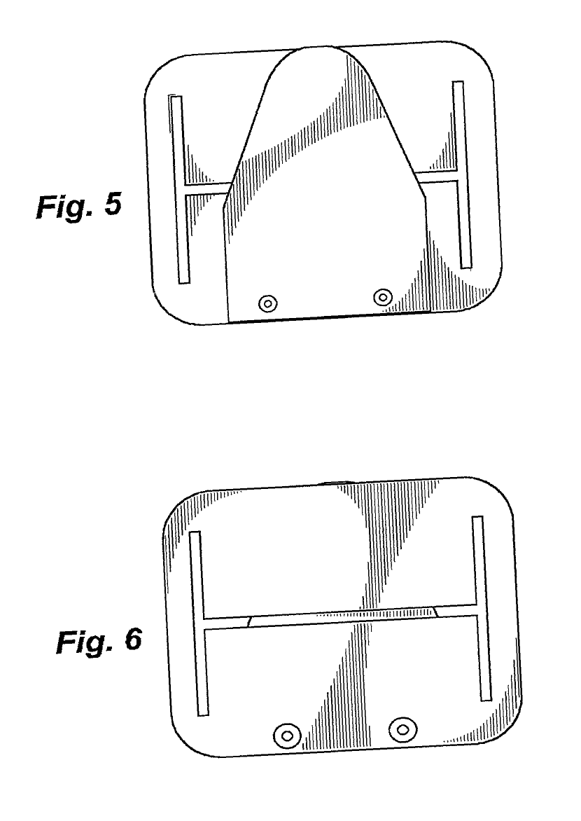

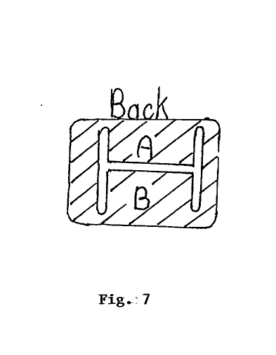

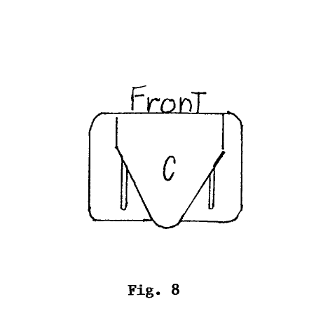

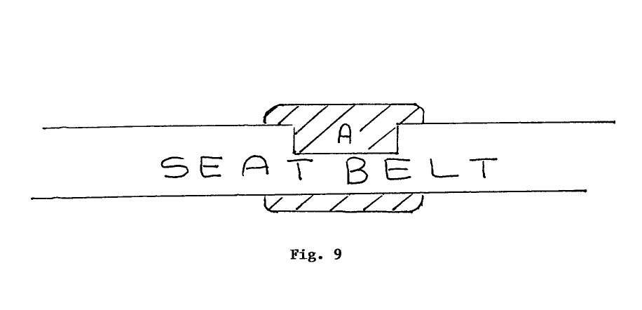

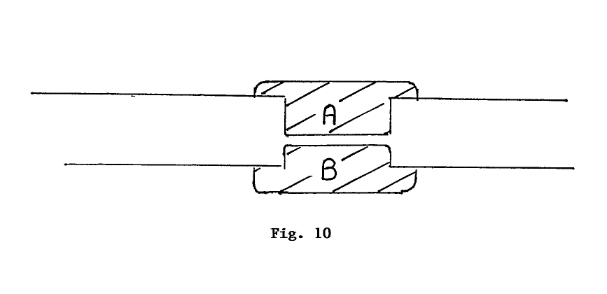

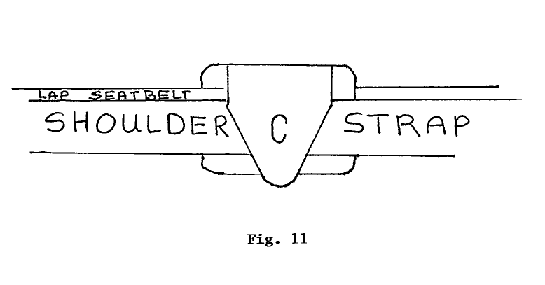

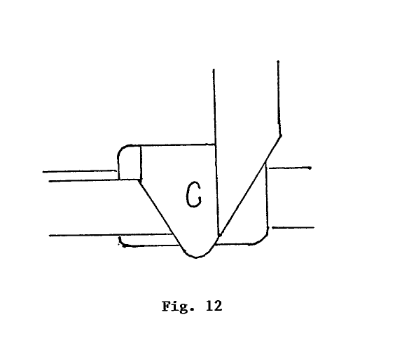

Instructions for using the present invention, referring to FIGS. 7-12:

1. Insert the top of the lap seatbelt into flap A. (This side of the Neck Reliever will be against the stomach of the user.)

2. Insert the bottom of the lap seatbelt into flap B.

3. Insert the shoulder strap of the seatbelt into flap C. (This side of the Neck Reliever will be on the outside.)

Adjust the Neck Reliever to a comfortable position for the shoulder strap.

I claim:

1. A shoulder strap neck reliever for a seatbelt having two straps, comprising:
a base with a front side and a back side, said base including an H-shaped slit having a left opening and a right opening, and
a clip connected to said base defining a strap holding area therebetween.

2. The shoulder strap neck reliever of claim 1, further comprising:
a first strap threaded into said left opening and passing along the back side of the base and threaded out through said right opening, and
a second strap clipped into said strap holding area.

3. The shoulder strap neck reliever of claim 2, wherein said first strap is a shoulder strap and said second strap is a lap strap.

4. The shoulder strap neck reliever of claim 2, wherein said first strap is a lap strap and said second strap is a shoulder strap.

5. The shoulder strap neck reliever of claim 3, further comprising slack pulled from said shoulder strap and wrapped around said clip.
